(19) United States
(12) Patent Application Publication
(10) Pub. No.: US 2012/0146898 A1
(43) Pub. Date: Jun. 14, 2012

(54) DISPLAY SYSTEM

(75) Inventor: TSUNG-YU LIN, Tu-Cheng (TW)

(73) Assignee: HON HAI PRECISION INDUSTRY CO., LTD., Tu-Cheng (TW)

(21) Appl. No.: 13/043,467

(22) Filed: Mar. 9, 2011

(30) Foreign Application Priority Data
Dec. 14, 2010 (TW) 99143590

(51) Int. Cl. G06F 3/033

(52) U.S. Cl. 345/157

(57) ABSTRACT

A display system includes a display having a display panel, a feature recognition apparatus, a distance detector and a controller. The feature recognition apparatus includes an image capturing unit for capturing images of objects present in a subject range in front of the display panel, and an image processing unit for processing the images to determine if a viewer present in the subject range. The distance detector is configured for determining whether a present viewer beyond a safe viewing distance limit. The controller is configured for controlling the display panel to operation there is no a viewer within a safe viewing distance limit, and controlling the display panel to be switched off if there is a viewer within the safe viewing distance limit.

### BACKGROUND

1. Technical Field

The present disclosure relates to display technologies, and particularly to a display system providing notification of a safe viewing distance.

2. Description of Related Art

Viewing display-equipped electronic devices such as televisions (TVs), computers and others, a safe viewing distance from the display is generally recommended. Failure to observe such safe distances may result in injury to a viewer.

What is needed, therefore, is a display system which can overcome the limitations described.

### BRIEF DESCRIPTION

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

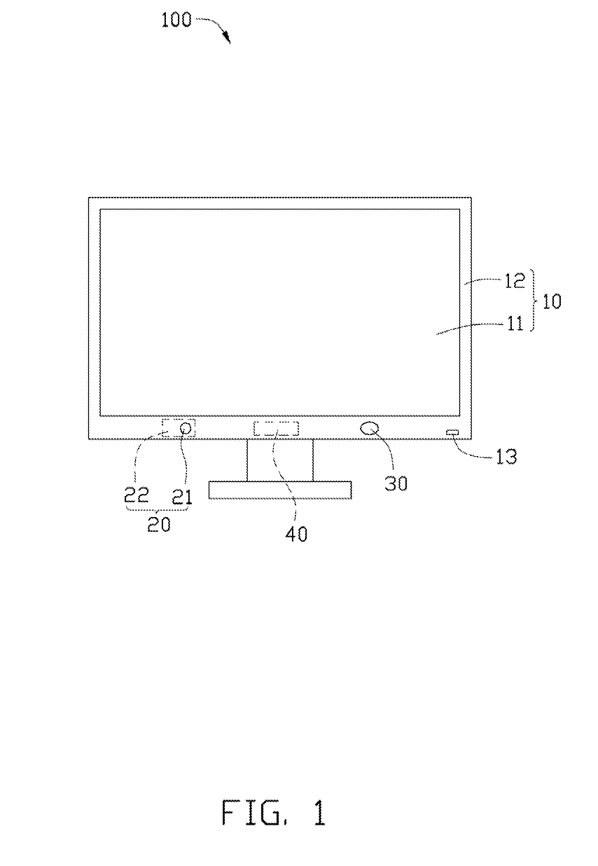

FIG. 1 is a front view of a display system in accordance with one embodiment.

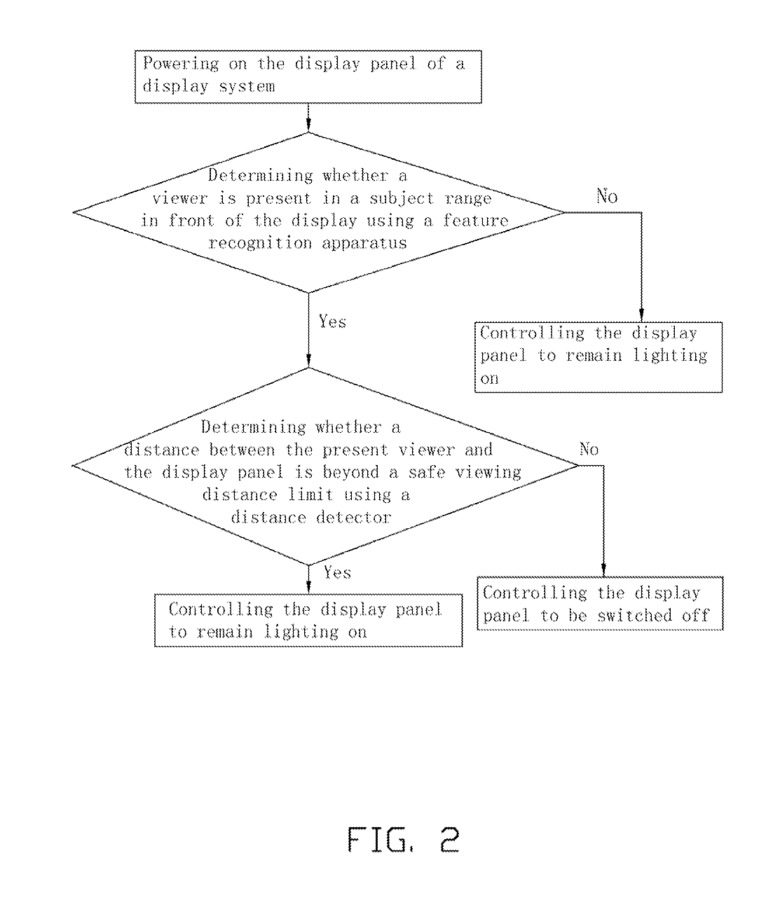

FIG. 2 is a flowchart of a control method for the display system.

### DETAILED DESCRIPTION

Embodiments of the present portable electronic device will now be described in detail below and with reference to the drawings.

Referring to FIG. 1, a display system 100 includes a display 10, a feature recognition apparatus 20, a distance detector 30 and a controller 40. The display system 100 can be deployed in electronic devices such as televisions (TVs), computers, and others.

The display 10 includes a display panel 11 surrounded by a bezel 12. The display panel 11 can be LCD, LED or CRT panel. The bezel 12 has a hollow inner space for receiving driving circuits, controllers and so on for the display panel 11.

The feature recognition apparatus 20 and the distance detector 30 are located in the bezel 12 and exposed to beyond the bezel 12. The feature recognition apparatus 20 and the distance detector 30 oppose the front of the display panel 11. The controller 40 is located in the inner space of the bezel 12.

The feature recognition apparatus 20 includes an image capturing unit 21 and an image processing unit 22. The image capturing unit 21 is exposed to beyond the bezel 12, and the image processing unit 22 is located in the inner space of the bezel 12. The image capturing unit 21 is configured for capturing images of objects present in a subject range in front of the display panel 11. The subject range constitutes the minimum safe viewing distance limit therein for the display, differing according to the specific device. The subject range may be greater than the minimum safe viewing distance limit. A lens module of the image capturing unit 21 can be selected according to the needed subject range. An example of the safe viewing distance limit for a TV is about 2.5 meters.

The image processing unit 22 includes a storage member storing a human facial image, and an image processor for comparing a currently captured image with stored images to determine whether a viewer is present within the subject range.

The distance detector 30 is initiated by determination by the image processing unit 22 that a viewer is present within the subject range, and can be automatically initiated upon receipt of a signal from the image processing unit 22. The distance detector 30 includes an infrared light emitter and a rangefinder. The rangefinder calculates the distance to the viewer based on reflected infrared light. If the distance is less than the safe viewing distance limit, the distance detector 30 can output a signal.

The controller 40 is electrically connected to the feature recognition apparatus 20, the distance detector 30 and the display 10. The controller 40 controls the display 10 when a power control 13 of the display 10 is activated. In particular, the controller 40 maintains operation of the display panel 11 when the image processing unit 22 determines no viewer in the subject range, and when distance detector 30 determines a viewer in the subject range is at a safe viewing distance, i.e., beyond the safe viewing distance limit.

Otherwise, when the distance detector 30 determines that a viewer is within the safe viewing distance limit, the controller 40 powers down the display panel 11, i.e., the display panel 11 is switched off.

FIG. 2 shows a method for controlling the display system 100 as follows.

The power control 13 of the display panel 11 is activated, and the display panel 11 is powered on. Feature recognition apparatus 20 is initialized, manually or automatically with activation of the power control 13.

If the image processing unit 22 of the feature recognition apparatus 20 determines the presence of a viewer within the subject range, the distance detector 30 is initialized to determine whether a viewer is within or beyond the safe viewing distance.

Finally, the controller 40 powers the display panel 11 to be lighting on or switched off according to the working principle detailed above.

It may not be necessary to initialize the power control 13 of the display panel 11. However, in some embodiments, the controller 40 can directly direct the power control 13 of the display panel 11 to power off.

In the disclosure, the display panel only operations/functions when no viewer is determined to be present within a safe viewing distance, through the cooperation of the feature recognition apparatus, the distance detector, and the controller.

It is understood that the described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A display system, comprising:
a display comprising a display panel;
a feature recognition apparatus comprising an image capturing unit for capturing images of objects present in a subject range in front of the display panel, and an image processing unit for analyzing the images to determine if a viewer is present in the subject range;
a distance detector configured for detecting a distance between the viewer and the display panel; and
a controller configured for controlling the display panel to remain lighting on if the image processing unit determines no viewer in the subject range, and the distance determined by the distance detector is beyond a safe viewing distance limit, and controlling the display panel to be switched off when the distance detector determines the distance is within the safe viewing distance limit.

2. The display system of claim 1, wherein the display further comprises a bezel surrounding the display panel, the image capturing unit and the distance detector mounted on the bezel.

3. The display system of claim 2, wherein the image processing unit and the controller are located within the bezel.

4. The display system of claim 1, wherein the distance detector comprises an infrared light emitter and a rangefinder.

5. The display system of claim 1, wherein the subject range is greater than the safe viewing distance limit.

6. The display system of claim 1, wherein the image processing unit comprises a human facial image storage member and an image processor for comparing a captured image with the human facial image stored in the storage member to determine if a viewer is present in the subject range.

7. A method for controlling a display system, the method comprising:
powering on the display panel of a display system;
determining whether a viewer is present in a subject range in front of the display using a feature recognition apparatus, wherein the feature recognition apparatus comprises an image capturing unit for capturing images of objects present in the subject range, and an image processing unit for processing the images to identify a present viewer; and
determining whether a distance between the present viewer and the display panel is beyond a safe viewing distance limit using a distance detector;
controlling the display panel to remain lighting on when the image processing unit determines no viewer in the subject range, and when distance detector determines a viewer in the subject range is beyond a safe viewing distance limit, and controlling the display panel to be switched off when distance detector determines the viewer is within the safe viewing distance limit.

8. The method of claim 7, wherein the controlling step is performed by a controller electrically connected to the feature recognition apparatus, the distance detector and the display.

9. A display system comprising:
a display having a display panel;
a feature recognition apparatus including an image capturing unit for capturing images of objects present in a subject range in front of the display panel, and an image processing unit for processing the images to determine if a viewer present in the subject range;
a distance detector configured for determining whether a present viewer beyond a safe viewing distance limit; and
a controller configured for controlling the display panel to remain lighting on if there is no a viewer within a safe viewing distance limit, and switching off the display panel if there is a viewer within the safe viewing distance limit.
